(19) United States
(12) Patent Application Publication
(10) Pub. No.: US 2015/0068045 A1
(43) Pub. Date: Mar. 12, 2015

(54) PLANAR CUTTING TOOL

(71) Applicant: Allen Innovative Concepts, LLC, Lincoln, NE (US)

(72) Inventor: Timothy E. Allen, Lennox, SD (US)

(21) Appl. No.: 14/484,011

(22) Filed: Sep. 11, 2014

Related U.S. Application Data
(60) Provisional application No. 61/876,247, filed on Sep. 11, 2013.

(51) Int. Cl. B26B 29/06; B26B 5/00

(52) U.S. Cl. CPC B26B 29/06; B26B 5/005
USPC 30/293; 30/294

(57) ABSTRACT

A planar cutting tool has a body comprising a first end, a second end and substantially flat portion that extends between the first and second portions. The substantially flat portion has a substantially flat top surface and a substantially flat bottom surface and a longitudinal axis extending between the body first and second ends. A first handle is coupled to the body proximate the front end and a second handle is coupled to the body proximate the body back end. A cutting assembly is operatively connected to the body and comprises: (i) a cutter having a cutting edge and a cutter holder for securing the cutter to the body in a position where the cutting edge is parallel to a plane that encompasses the longitudinal axis.

### CLAIM OF PRIORITY

This application claims priority to U.S. Provisional Patent Application Ser. No. 61/876,247, filed Sep. 11, 2013, entitled “Planer Cutting Tool,” the entire disclosure of which is incorporated by reference herein.

### BACKGROUND

Residential and commercial construction requires cutting tools for use on heavy-duty drywall, cementitious wall board, and other sheet and roll materials. Current methods for cutting these materials requires the marking and scoring of the material with a standard utility knife, followed by popping the material to break along the scored line. Thicker materials are difficult to score and often require repeated strokes to score to an adequate depth to break the material along the scored line. In addition, continuous cutting operations require a high exertion of effort that may be hard on a person's hands, wrists, and elbows, which can lead to long-term health effects from the repetitious motions. Accordingly, there is a need for improved methods and apparatuses for facilitating the cutting of heavy-duty drywall, cementitious wall board, and other materials.

Various embodiments of the present methods and apparatuses recognize and address the foregoing considerations, and others, of prior art methods and apparatuses.

### SUMMARY

In general, in various embodiments, a planar cutting tool comprises a body that includes: (i) a substantially flat top surface; (ii) a substantially flat bottom surface; (iii) a front end; (iv) a back end; and (v) a longitudinal axis extending between the body front end and the body back end, parallel to the body top surface. A first handle is coupled to the body proximate the front end. A second handle is coupled to the body proximate the body back end. A cutting assembly is operatively connected to the body and comprises: (i) a cutter having a cutting edge and a cutter holder for securing the cutter to the body in a position where the cutting edge is parallel to a plane that encompasses the longitudinal axis.

In various embodiments, a planar cutting tool comprises a body that includes a front end, a back end, and a longitudinal axis extending between the body front end and the body back end. At least one handle coupled to the body intermediate the body front and back ends. A cutter assembly operatively connected to the body comprises a cutter housing for securing the cutter to the body in a position where the cutting edge is coplanar with the longitudinal axis, a front mount operatively connected to the body and the cutter housing, and a rear mount operatively connected to the body and the cutter housing. The cutter assembly further comprises a support bracket that is: (i) adjustably connected to the front mount; (ii) adjustably connected to the rear mount; and (iii) operatively connected to the cutter housing.

A planar cutting tool, according to various embodiments, comprises a substantially rectangular body that includes: (i) a front end; (ii) a back end; (iii) a substantially flat top surface that extends between the front and back ends; and (iv) a longitudinal axis extending between the body front end and the body back end. At least one handle coupled to the body intermediate the body front and back ends. A cutter having a cutting edge operatively connected to the body, wherein the cutting edge at least partially extends through the body so that the cutting edge is positioned coplanar with the body longitudinal axis and at least a portion of the cutter is perpendicular to the top surface of the substantially rectangular body.

### BRIEF DESCRIPTION OF THE DRAWINGS

Reference will now be made to the accompanying drawings, which are not necessarily drawn to scale, and wherein:

FIG. 1 is a perspective view of a planar cutting tool in accordance with a first embodiment.

FIG. 2 is a right side view of the planar cutting tool of FIG. 1.

FIG. 3A is a front view of the planar cutting tool of FIG. 1.

FIG. 3B is a top view of the planar cutting tool of FIG. 1.

FIG. 4 is a perspective view of a planar cutting tool in accordance with a second embodiment.

FIG. 4A is a partially exploded perspective view of the planar cutting tool of FIG. 4.

FIG. 5 is a right side view of the planar cutting tool of FIG. 4.

FIG. 6 is a perspective view of a planar cutting tool in accordance with a third embodiment.

FIG. 7 is a right side view of the planar cutting tool of FIG. 6.

FIGS. 8 and 9 are perspective views of a planar cutting tool in accordance with a fourth embodiment.

FIG. 10 is a right side view of the planar cutting tool of FIGS. 8 and 9.

FIG. 11 is a perspective view of a planar cutting tool in accordance with a fifth embodiment.

FIG. 12 is a right side view of the planar cutting tool of FIG. 11.

FIGS. 13 and 14 are perspective views of a planar cutting tool in accordance with a sixth embodiment.

FIG. 15 is a left side view of the planar cutting tool of FIGS. 13 and 14.

FIG. 16A is a perspective view of a planar cutting tool in accordance with a seventh embodiment.

FIG. 16B is a left side view of the planar cutting tool of FIG. 16A.

### DETAILED DESCRIPTION OF VARIOUS EMBODIMENTS

Various embodiments will now be described more fully herein with reference to the accompanying drawings, in which various relevant embodiments are shown. The invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

### Overview

In general, various embodiments of a planar cutting tool for cutting heavy drywall and cementitious wall board, composite ceiling tiles, foam insulation, or any other of a number of various sheet and roll materials used in commercial and residential building construction are described. According to particular embodiments, the planar cutting tool includes a planar body, two handles, a cutter (e.g., a thin cutting blade for cutting the heavy drywall) that is positioned parallel to a longitudinal axis of the planar body (e.g., coplanar with or parallel to a plane encompassing the longitudinal axis of the planar body), and a cutter assembly that holds the cutter in a particular position on the planar body (although, in various embodiments, the cutter position may be adjustable). It should be understood, in light of this disclosure, that the planar body, the two (or more) handles, cutter, and/or cutter assembly may be in various configurations, including one or more configurations that allow the cutter to be pushed by an operator and one or more configurations that allow the cutter to be pulled (drawn) by the operator.

In a particular example, an operator uses the planar cutting tool by placing a bottom surface of the planar body on the piece of heavy drywall, aligning the cutter with a particular indication (e.g., a line) of where the piece of heavy drywall is to be cut (e.g., the piece of heavy drywall is to be cut in half, a specific size of drywall is to be cut from a larger piece of drywall, etc.). Continuing with this example, the operator holds the planar cutting tool by the first handle and the second handle and pushes the planar cutting tool forward, exerting forward and downward force so that the cutter slices the heavy drywall along the particular indication.

### Planar Cutting Tool

### Planar Cutting Tool Structure

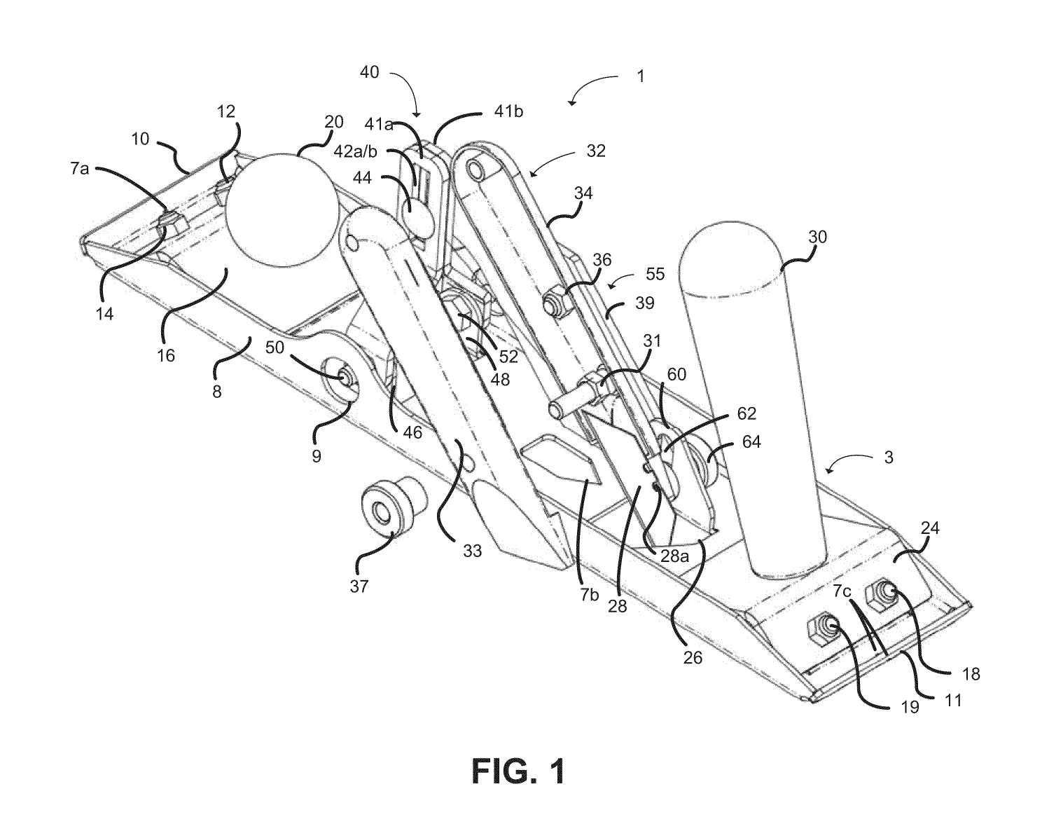

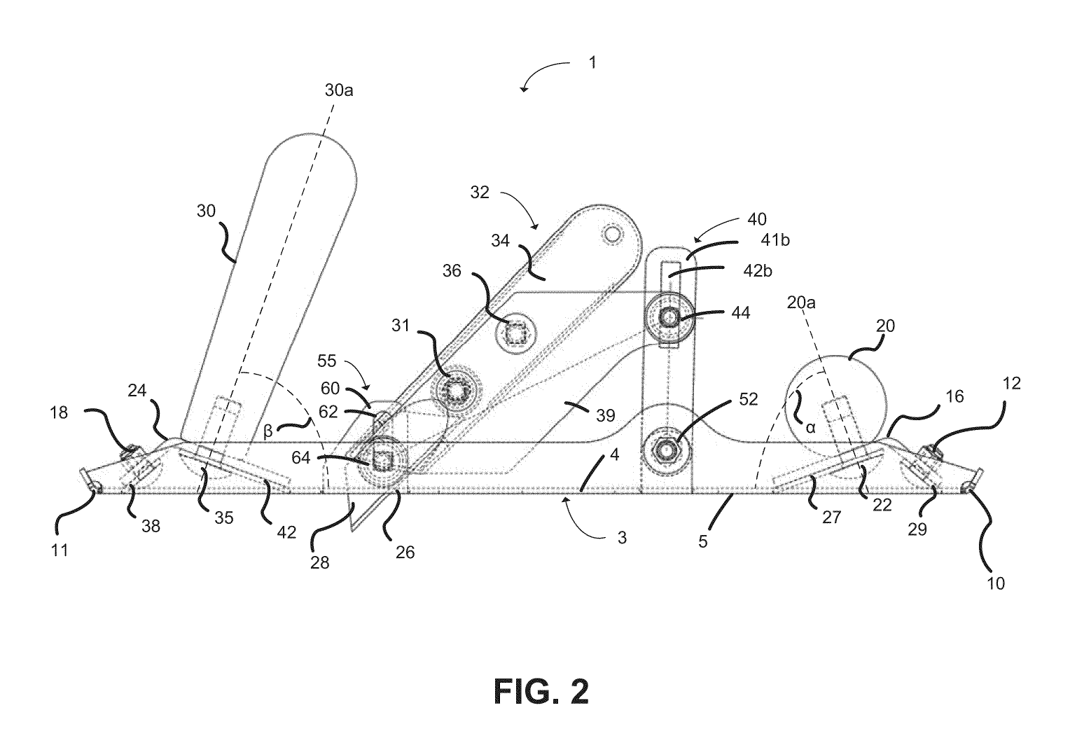

Referring to FIGS. 1-3B, an embodiment of a planar cutting tool is shown. Referring particularly to FIG. 1, a planar cutting tool 1 generally has a planar body 3 having a bottom surface 5 (FIG. 2), a front handle 20 and a rear handle 30 operatively coupled to the planar body 3, and a cutting assembly 32 coupled to the planar body 3. The cutting assembly 32 has a cutter 28 that extends through the planar body bottom surface 5.

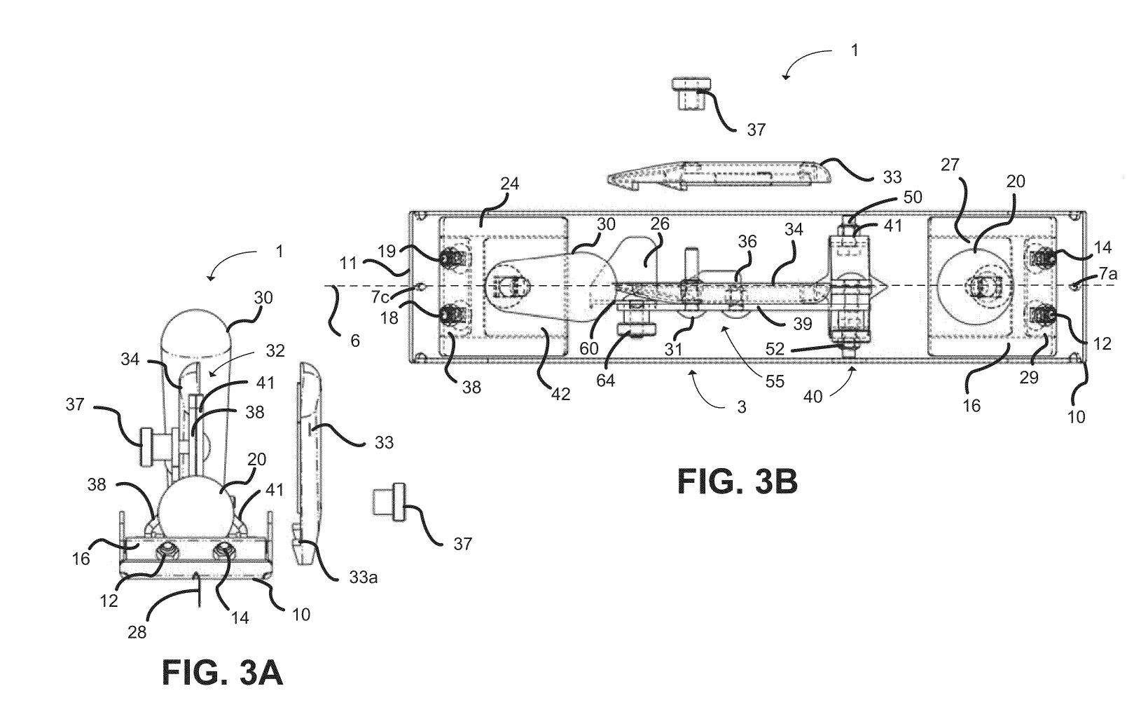

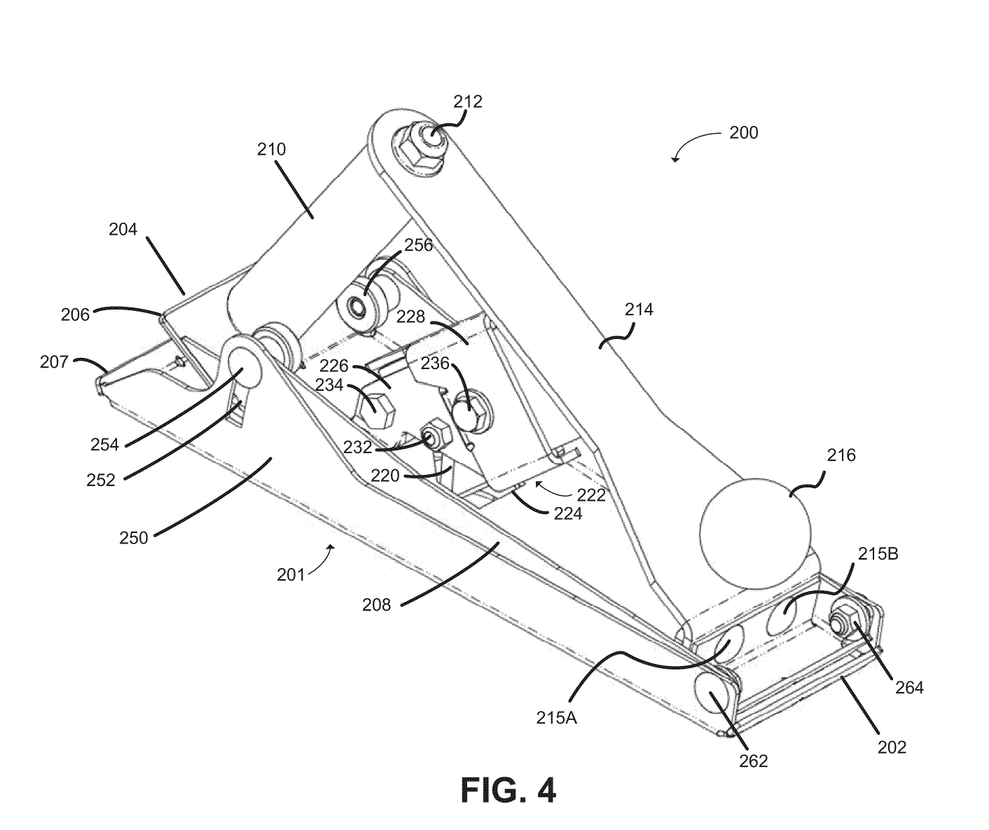

Referring particularly to FIG. 1, the planar body 3 is generally rectangular in shape and has a top surface 4 (FIG. 2), and the bottom surface 5 (FIG. 2), a longitudinal centerline 6 (FIG. 3B), one or more side walls 8 that may be formed at any suitable height depending on the use of the planar cutting tool, a front end 10, and a rear end 11. The planar body 3 defines at least one opening 26, which is configured to allow the cutter 28 to pass through the planar body 3, as further discussed below. The side walls 8 may be an integral part of the planar body 3 (e.g., the planar body 3 and the side walls 8 may be integrally formed). In other embodiments, the side walls 8 may be separate parts that are attached to the planar body 3 by suitable fasteners (e.g., screws, rivets, weldments, etc.). The side walls 8 have one or more openings 9 that provide access to fasteners (e.g., fastener 50) that allow the user to make adjustments to the cutting tool 1. Additionally, in various embodiments, the planar body 3 includes one or more holes or notches 7a, 7b, and 7c (e.g., at a longitudinal centerline 6 (FIG. 3B)) that function as a cutting guide.

The planar body 3 is formed from a substantially thin rectangular (e.g., two opposite sides are longer than the remaining two opposite sides) shaped plate of material having a thickness of between 1/32-1½ inches (e.g., from the bottom surface 5 to the top surface 4). In particular embodiments, the plate thickness is ¼ of an inch thick. The planar body 3 is about one to five inches wide by about five to 24 inches long. In a particular embodiment, the planar body 3 is about three inches wide by about 13 inches long. In one or more embodiments, the planar body 3 is about 2½ inches wide by about 12 inches long. In another embodiment, the planar body 3 is about four inches wide by about 15 inches long. In further embodiments, the planar body may be formed by other shaped plates (e.g., substantially circular, oval, triangular, or in any other polygonal shape). The planar body 3 is constructed (partially or wholly) using stainless steel. It should be understood from reference to this disclosure that the planar body 3 may be formed from any suitable material such as steel, ceramics, polymers, alloys, composites or any other suitable material.

The plate of the planar body 3 has the at least one opening 26 that is sized and shaped to allow the cutter 28 of the cutting assembly 32 to extend through the planar body 3. The opening 26 is located proximate the planar tool rear end 11 (e.g., the opening 26 may be located closer to the planar tool rear end 11 than the planar tool front end 10). In a particular embodiment, the opening 26 may be located about 60% of the distance from the planar tool front end 10 to the planar tool rear end 11. The location of the cutter 28 and the opening 26 allow the user to exert greater force on the rear handle 30 than is necessary on the front handle 20, which may result in better ergonomics and leverage for the user during the cutting process. The opening 26 is formed during the formation of a rear internal bracket 60 (e.g., the rear internal bracket 60 is formed by cutting three sides of the bracket from the planar body plate and bending the bracket into place along a fourth side). In various other embodiments, the opening 26 may be formed via a punch, drill, etc.

Referring to FIG. 2, the front handle 20 is generally spherical in shape and is formed from a polymer material. In various embodiments, the front handle 20 may be formed from any suitable material such as metals, alloys, ceramics, polymers and composites. The front handle 20 has a threaded bore formed therein to allow the front handle 20 to connect to the planar body 3. The threaded bore is centered on a vertical central axis 20a. It should be understood that the front handle 20 may be formed in any suitable shape such as spherical, circular, polygonal, or cylindrical so long as the shape assists the user in gripping the handle (e.g., a user can wrap their hand around and/or over the front handle 20). The front handle 20 is operatively connected to the planar body 3 by a front handle mounting plate 16 and a first and second internal bracket 27 and 29 using a variety of fasteners as described in more detail below.

Referring again to FIG. 1, the front handle mounting plate 16 is formed from a thin metal angled plate that spans the width of the planar body 3. In one or more embodiments, the front handle mounting plate 16 may span less than the width of the planar body 3. The front handle mounting plate 16 may include one or more smooth holes (not numbered) that receive one or more fasteners, such as fasteners 12 and 14. In other embodiments, the holes in the front handle mounting plate 16 may be threaded such that fasteners 12 and 14 are threadably coupled directly with the front handle mounting plate 16 without the use of bolts.

Returning to FIG. 2, the internal brackets 27 and 29 are an integral part of the planar body 3 (e.g., the internal brackets 27 and 29 are formed by cutting three sides of each of the internal brackets 27 and 29 from the planar body plate and bending each one of the brackets into place along a respective fourth side). In one or more embodiments, the internal brackets 27 and 29 are operatively connected to the planar body 3 by, for example, welding, an adhesive, one or more suitable fasteners, etc. (not shown). Each internal bracket 27 and 29 contains one or more holes (not numbered) for connecting the front handle 20 and the front handle mounting plate 16 to the planar body 3.

Referring to FIGS. 1, 2, and 3B, the front handle mounting bracket 16 is connected to the planar body 3 at one end via the second internal bracket 29 using fasteners 12 and 14, which in the embodiment shown are nuts and bolts. That is, a bolt is passed through an opening (not numbered) through the second internal bracket 29 that aligns with a corresponding opening (not numbered) in the front handle mounting bracket 16. The nut is then threadably fastened to each bolt to couple the front handle mounting bracket 16 to the second internal bracket 29. The opposite side of the front handle mounting bracket 16 contains at least one opening that aligns with a corresponding opening in the first internal bracket 27. Thus, a threaded bolt 22 is passed through the aligned openings in the front handle mounting bracket 16 and first internal bracket 27, and the front handle 20 is threadably attached to the threaded bolt 22 using the threaded bore formed in the handle.

In the embodiment shown in FIG. 2, once the front handle 20 is mounted to the planar body 3 using the front handle mounting bracket 16, the central vertical axis 20a of the front handle 20 forms an acute angle α with respect to the top surface 4 of the planar body 3. In one or more embodiments, the front handle 20 may be located substantially laterally in the center of the planar body (e.g., the front handle 20 may be located substantially proximate the planar body front end 10 or may be positioned substantially along the longitudinal centerline 6 (FIG. 3B)) and may be mounted at any suitable angle (e.g., the central axis 20a may be disposed at any angle from zero to ninety degrees with respect to the top surface 4 of the planar body plate).

The rear handle 30 is generally cylindrical in shape, and is formed from a polymer material. In one or more embodiments, the rear handle 30 may be formed from any suitable material such as metals, alloys, ceramics, polymers, and/or composites, and may be in any suitable shape such as circular, polygonal, or spherical, so long as the shape assists the user in gripping the handle (e.g., a user can wrap their hand around and/or over the rear handle 30). The rear handle 30 has a threaded bore formed therein that is centered on a vertical central axis 30a. The rear handle 30 is operatively connected to the planar body 3 by a rear handle mounting plate 24 and a third and fourth internal bracket 38 and 42 using a variety of fasteners as described in more detail below. It should be understood, in light of this disclosure, the rear handle 30 may be operatively connected to the planar body 3 in any other suitable way, including being integrally formed with the planar body 3.

Referring again to FIG. 1, the rear handle mounting plate 24 is formed from a thin metal angled plate that spans the width of the planar body 3. The rear handle mounting plate 24 may include one or more smooth holes (not numbered) that receive one or more fasteners, such as fasteners 18 and 19, which in the present embodiment are nuts and bolts. In one or more embodiments, the holes in the rear handle mounting plate 24 may be threaded such that fasteners 18 and 19 are threadably coupled directly with the rear handle mounting plate 24 without the use of bolts.

Returning to FIG. 2, the internal brackets 38 and 42 are an integral part of the planar body 3 (e.g., the internal brackets 38 and 42 are formed by cutting three sides of each of the internal brackets 38 and 42 from the planar body plate and bending each one of the brackets into place along a respective fourth side). Each internal bracket 38 and 42 contains one or more holes (not numbered) for connecting the rear handle 30 and the rear handle mounting plate 24 to the planar body 3. It should be understood that, in one or more embodiments, the internal brackets 38 and 42 may be operatively connected to the planar body 3 by, for example, welding, an adhesive, one or more suitable fasteners, etc. (not shown).

The rear handle mounting plate 24 is connected to the planar body 3 at one end via the third internal bracket 38 using fasteners 18 and 19, which, in the embodiment shown in FIG. 1, are nuts and bolts. That is, a bolt is passed through an opening (not numbered) through the third internal bracket 38 that aligns with a corresponding opening (not numbered) in the rear handle mounting plate 24. The nut is then threadably fastened to each bolt to couple the rear handle mounting plate 24 to the third internal bracket 38. The opposite side of the rear handle mounting plate 24 contains at least one opening that aligns with a corresponding opening in the internal bracket 42. Thus, a threaded bolt 35 is passed through the aligned openings in the rear handle mounting plate 24 and internal bracket 42, and the rear handle 30 is threadably attached to the threaded bolt 35 using the threaded bore formed in the rear handle 30.

In the embodiment shown in FIGS. 1-3B, once the rear handle 30 is mounted to the planar body 3 using the rear handle mounting plate 24, the central vertical axis 30a of the rear handle 30 forms an acute angle β with respect to the top surface 4 of the planar body 3 (FIG. 2). The rear handle 30 is located substantially laterally in the center of the planar body (e.g., the central vertical axis 30a of the rear handle 30 is approximate on the longitudinal centerline 6 of the planar body 3) and may be mounted at any suitable angle (e.g., the central axis 30a may be disposed at any angle from zero to 90 degrees with respect to the top surface 4 of the planar body 3).

Referring particularly to FIG. 1, the cutter assembly 32 includes the cutter 28, and a cutter housing having a left housing portion 33 and a right housing portion 34 that together substantially hold the cutter 28 in a position where at least a portion of the cutter 28 extends through the bottom surface 4 of the planar body 3. This configuration also prevents lateral movement of the cutter 28 relative to the longitudinal centerline 6 of the planar body 3 (e.g., from the front end 10 to the rear end 11). The left and right housing portions 33 and 34 engage a notch 28a formed in the cutter 28 via a lip 33a formed in the left housing portion 33 (FIG. 3A), which prevents the cutter from sliding into and out of the cutter housing while another portion of the cutter 28 extends through the planar body 3.

The left and right housing portions 33 and 34 are made of die cast aluminum. In other embodiments, the left and right housing portions 33 and 34 may be made of hard plastic, steel, carbon fiber, ceramic or any suitable composite material. It should be understood, in light of this disclosure, that the left housing portion 33 and the right housing portion 34 may be made of the same or different materials (e.g., the left housing portion 33 may be made of a certain type of aluminum and the right housing portion 34 may be made of a different type of aluminum or other material).

The cutter 28 may be any suitable instrument for cutting materials. In the embodiment shown in FIGS. 1 and 2, the cutter 28 is a razor-type blade with one or more notches (e.g., notch 28a) formed in a non-cutting side, which may be used to at least partially hold the cutter 28 in position, as described above. In particular embodiments, the cutter 28 may be a thin utility-type blade. In various other embodiments, the cutter 28 may be a hook blade, a tile blade, or a cutting implement other than a blade (e.g., a laser, a fluid stream, or an electric discharge device) depending upon the material being cut. It should be understood, in light of this disclosure, that the cutter 28 may represent more than one cutter. In various embodiments, the planar cutting tool 1 may include two or more cutters in any suitable arrangement (e.g., side by side, offset, and/or in a line along the longitudinal centerline 6).

It should be understood that the cutter assembly 32 may be any suitable cutting assembly. For example, in a particular embodiment, the cutting assembly 32 may be a retail utility knife, such as a Stanley™ Fat Max™ utility knife, which includes the cutter 28 and left and right housing portions 33 and 34. In various embodiments, the cutting assembly 32 may be a custom assembly (e.g., not typically sold separately in stores). In particular embodiments, the cutting assembly 32 is configured to store at least one spare cutter (e.g., within the left and right housing portions 33 and 34). In this embodiment (and others) the cutter 28 may be changeable (e.g., a user can change the cutter 28 when it becomes dull, if it breaks, etc.).

Referring particularly to FIGS. 1, 3A, and 3B, the cutting assembly 32 includes any number of fasteners, including a fastener 31 that operates to hold the left and right housing portions 33 and 34 together, and a fastener 36, which operates to secure the cutter assembly to the planar body 3 via a cutter assembly adjustable support 39. The fastener 31 is a rivet with an adjustable nut 37, which functions to at least partially hold the cutter 28 in place. It should be understood, in light of this disclosure that fasteners 31 and 36 may be any suitable fastener and/or fasteners, including, for example, a nut and bolt, a rivet and nut, a weldment, etc.

Referring to FIGS. 1, 2, and 3B, as mentioned above, the cutter assembly 32 is operatively connected to the cutter assembly adjustable support 39 by the fastener 36. The cutter assembly adjustable support 39 is generally shaped as a substantially flat parallelogram and is coupled to the planar body 3 by a cutter front mount bracket assembly 40 that is “A-shaped” and a cutter rear mount bracket 55. The cutter assembly adjustable support 39 is formed from a metal material, but may be any suitable material(s), including (but not limited to), steel, stainless steel, titanium, any suitable plastic (e.g., PVC), carbon fiber, and/or any composite material.

Referring particularly to FIGS. 1 and 3B, the cutter front mount bracket assembly 40 has two mirror-image bent struts 41a and 41b that, together, form the “A-shape”, that couple to the planar body 3 by internal brackets 46 and 48 via respective fasteners 50 and 52. The internal brackets 46 and 48 are integrally formed with the planar body 3 (e.g., the internal bracket 46 is partially cut from the planar body 3 and bent into a suitable position). In other embodiments, the internal brackets 46 and 48 may be separately formed and connected to the planar body 3 by suitable fasteners such as rivets, weldments, screws, or bolts.

Each A-shaped strut extends upward perpendicular to the top surface 4 (FIG. 2) of the planar body 3 and contains a respective slot 42a and 42b formed through the strut. A first end of the cutter assembly adjustable support 39 is movably coupled to the A-shaped struts via an adjustable fastener 44 that passes through the aligned slots 42a and 42b and a hole (not numbered) formed in the first end of the cutter assembly adjustable support 39. The mirror-image bent struts 41a and 41b are formed from a metal material, but may be any suitable material(s), including (but not limited to), steel, stainless steel, titanium, any suitable plastic (e.g., PVC), carbon fiber, and/or any composite material.

Referring to FIGS. 1 and 2, the cutter assembly adjustable support 39 is operatively coupled to the cutter rear mount assembly 55 via a fastener 64 and a rear mount bracket 60. The rear mount bracket 60 is integrally formed with the planar body 3 (e.g., three sides of the rear mount bracket 60 are cut from the planar body 3 and the rear mount bracket 60 is positioned by bending the rear mount bracket about a fourth side). The rear mount bracket 60 has a generally oblong slot 62 that receives the fastener 64. That is, the fastener 64 passes through a hole (not shown) in the cutter assembly adjustable support 39 and the slot 62 to couple the cutter adjustable support 39 to the rear mount bracket 60. The fastener 64 is a carriage head bolt and knurled O.D. nut type fastener, but it should be understood that the fastener 64 may be any suitable fastener, including, but not limited to a weldment, a nut and bolt wingnut, a screw, a snap, etc.

### Planar Cutting Tool Operation

The planar cutting tool 1 may have many uses, including cutting heavy drywall and cementitious wall board, composite ceiling tiles, foam insulation, or any other of a number of various sheet or roll materials used in commercial and residential building construction. The planar cutting tool handles 20 and 30 are sized and located to provide ergonomic operation using two hands, with the front handle 20 generally providing guiding and down force on the plane and the rear handle 30 generally providing down force as well as force for forward motion, generally away from an operator (e.g., the operator pushes the planar cutting tool 1 away from themselves for cross-cutting the heavy drywall; or pushed parallel to operator for longitudinal cuts). In this way, the planar cutting tool 1 may offer substantial force applied to the cutting edge (e.g., of cutter 28) and ergonomic efficiency by enabling an operator to push the planar cutting tool 1 primarily with the operator's upper body.

The planar cutting tool 1 is configured so that the cutter 28 is adjustable. As discussed above, the cutter assembly adjustable support 39 is connected to the cutter front mount assembly 40 and the cutter rear mount assembly 55 such that the cutter assembly 32 is adjustable in a vertical direction (e.g., perpendicular to a top surface of the planar body 3), via the slots 42a and 42b in the front mount assembly 40 and the slot 62 in the rear mount assembly 55. The angle of the cutter 28 relative to a bottom surface 5 of the planar body 3 can be adjusted by loosening the fasteners 50 and 52 of the front mount assembly and tilting the A-shaped struts 41a and 41b to an angle other than 90 degrees with respect to the top surface 4 of the planar body 3 in conjunction with adjusting the fastener 44 and fastener 64 of the rear mount assembly 55. In this way, the angle and depth of the cutter 28 (which is held by the cutter assembly 32) can be adjusted to any suitable angle and depth by adjusting the cutter front mount assembly 40 (e.g., by rotating the cutter front mount assembly about the fasteners 50 and 52) and the cutter assembly adjustable support 39 (e.g., by adjusting the cutter assembly adjustable support 39 vertically via fastener 44 at the cutter front mount assembly 40 and fastener 64 at the cutter rear mount assembly 55).

### Planar Cutting Tool Alternate Embodiments

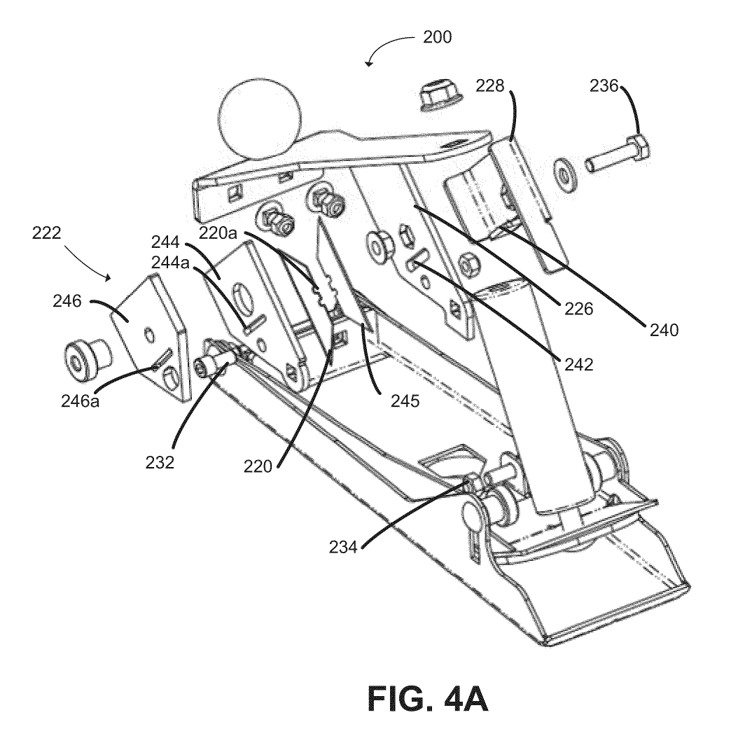

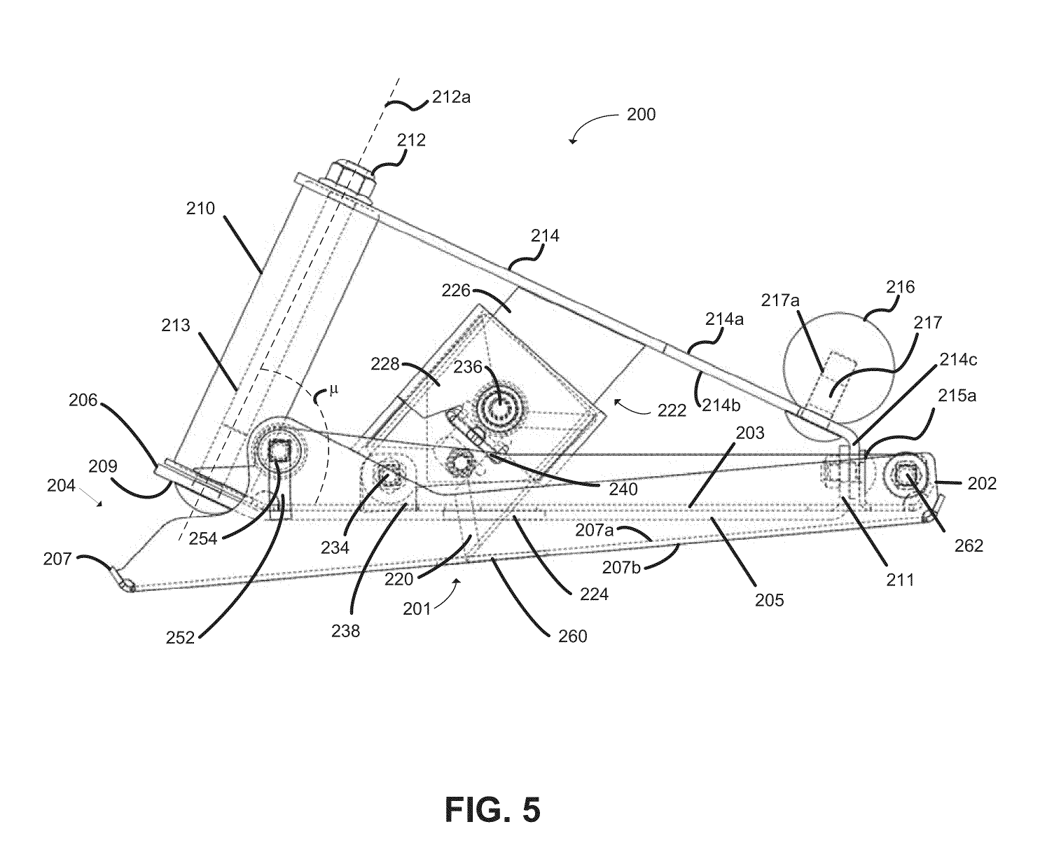

Several alternative embodiments of the planar cutting tool are described in FIGS. 4-15. The alternate embodiments may include features that are, in some respects, similar to the various components described above in FIGS. 1-3B. For purposes of brevity and clarity, selected distinguishing features of these alternative embodiments are discussed below. For some of the alternate embodiments, for example, the cutter assembly could be reversed to orient the cutter so the planar cutting tool could be pulled generally toward the operator to cut material (e.g., as opposed to pushing the planar cutting tool).

### First Alternate Embodiment

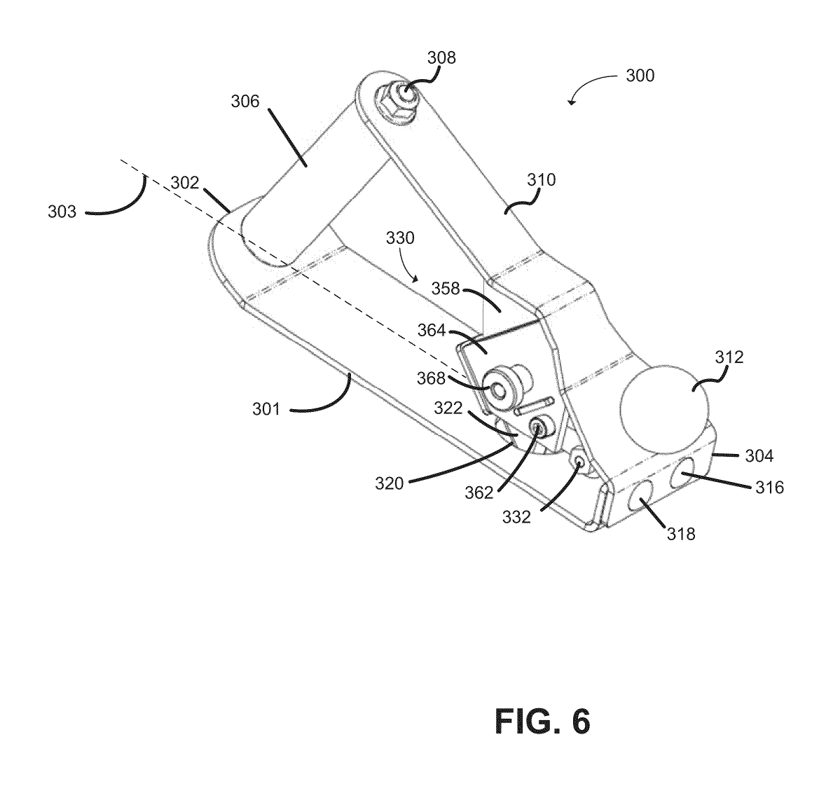

As shown in FIGS. 4-5, a planar cutting tool 200 includes a planar body assembly 201, a rear handle 210, a support arm 214, a front handle 216, and a cutter holding assembly 222. Turning specifically to FIG. 5, the planar body assembly 201 has a front end 202, a rear end 204, a first planar body 206, and a second planar body 207. The first planar body 206 includes a top surface 203, a bottom surface 205, a first upward bend 209 proximate the rear end 204 of the planar body assembly 201 (e.g., the planar body 206 is bent along a lateral axis, so a portion of the planar body 206 is bent in an upward direction relative to the top surface 203 of the planar body 206), and a second upward bend 211 proximate the front end 202 of the planar body assembly 201 for operatively coupling the planar body 206 to the support arm 214, as further discussed below. The planar body 206 includes one or more side walls 208 (e.g., a side wall on each side) (FIG. 4), which may be integrally formed with the planar body 206. The one or more side walls 208 include one or more slots (not shown) to operatively connect to the second planar body 207. The planar body 206 defines an opening 224 which a cutter 220 passes through. It should be understood, in light of this disclosure that the first planar body 206 is substantially similar to the planar body 3 as shown in FIG. 1, but it should be understood that the planar body 206 may be a different length, width, and/or material than the planar body 3 in FIG. 1. The second planar body 207 will be discussed in further detail below.

Referring particularly to FIG. 5, the rear handle 210, located proximate the rear end 204 of the first planar body 206, is coupled to the first planar body 206 and the support arm 214 via a fastener 212. The planar body 206 includes a hole (not shown) proximate the rear end 204 of the planar body that aligns with a through-bore 213 formed in the rear handle 210 and a hole proximate a rear end of the support arm 214 (not shown), which receives the fastener 212. The fastener 212 is a nut and bolt configuration, but it should be understood that the fastener 212 may represent any suitable fastener or fasteners to operatively couple the rear handle 210 to the first planar body 206 and the support arm 214. The through-bore 213 forms a central vertical axis 212a of the rear handle 210. The rear handle 210 is substantially cylindrical and when mounted on the planar body 206, the central vertical axis 212a forms an acute angle μ with the top surface 203 of the planar body 206. It should be understood, in other embodiments, that the rear handle 210 may be formed in any suitable shape, such as an elongated rectangle, a substantially conical shape, etc., and may be operatively connected to the planar body 206 and the support arm 214 in any suitable way, such as by being integrally formed with either the planar body 206, the support arm 214, or both.

Referring to FIGS. 4 and 5, the support arm 214 is a substantially flat, elongated metal plate with a top surface 214a, a bottom surface 214b, and a substantially downward bend 214c. The support arm 214 is operatively connected to the substantially spherical front handle 216 via an at least partially threaded bolt 217. The support arm 214 includes a hole (not shown) for receiving the at least partially threaded bolt 217, which is threadably connected to the front handle 216 via a threaded bore 217a in the front handle 216 (e.g., the at least partially threaded bolt 217 is received through the hole (not shown) in the support arm 214 and the front handle 216 screws onto the at least partially threaded bolt 217). It should be understood that the front handle 216 may be formed in any suitable shape such as rectangular, square, substantially T-shape, etc., or the front handle 216 may be integrally formed with the support arm 214, and the at least partially threaded bolt 217 may represent any suitable fastener including, but not limited to, a weldment, a screw, a nut and bolt configuration, a snap, an epoxy, etc.

The support arm 214 is operatively coupled to the planar body 206 proximate the second upward bend 211 of the planar body 206 and the downward bend 214c of the support arm 214 via fasteners 215a and 215b (FIG. 4). The planar body second upward bend 211 and the support arm downward bend 214c each include holes (not shown) for receiving the fasteners 215a and 215b, which are a nut and bolt configuration. It should be understood that the fasteners 215a and 215b may represent any one or more suitable fasteners, such as one or more weldments, one or more screws, one or more snaps, one or more epoxies, etc. Additionally, it should be understood that the support arm 214 and the planar body 206 may be at least partially integrally formed.

The support arm 214 is operatively connected to the cutter holding assembly 222 by a weldment (not shown) to the bottom surface 214b of the support arm 214 and a cutter support arm 226. The cutter support arm is also operatively coupled to the planar body 206 by a fastener 234 and an internal bracket 238, which is welded to the planar body 206 (weldment not shown). The cutter holding assembly 222 operatively positions the cutter 220 through the opening 224.

Turning to FIG. 4A, the cutter holding assembly 222 includes a fastener assembly 236, a cutter support bracket 228, the cutter support arm 226, the cutter 220, a spare cutter 245, a first cutter support plate 244, a second cutter support plate 246, and a fastener 232. The cutter support bracket 228 is formed from metal, is substantially C-shaped, and includes a lip 240, which passes through a slot 242 in the cutter support arm 226, for holding the cutter 220 in position via a notch 220a in a non-cutting side of the cutter 220 (e.g., the lip 240 engages the notch 220a and at least partially prevents the cutter 220 from moving into the cutter holding assembly 222 or out of the cutter holding assembly 222). The lip 240 also passes through a slot 244a in the first cutter support plate 244 and a slot 246a in the second cutter support plate 246. The first cutter support plate 244 and the second cutter support plate 246 at least partially hold the cutter 220 in position by pressing and holding the cutter 220 between the first cutter support plate 244 and the cutter support arm 226 via the fastener 232 and the fastener assembly 236. The cutter support assembly 222 also holds the spare cutter 245 between the first cutter support plate 244 and the cutter support arm 226 (e.g., an operator can change the cutter 220 with the spare cutter 245 if the cutter 220 breaks, becomes dull, etc.). It should be understood that the cutter 220 may be any suitable cutter, including, but not limited, to the cutter 28 described above in FIG. 1.

Referring once again to FIG. 4, as mentioned above, the planar body assembly 201 includes the second planar body 207, which, as shown in FIG. 5, may enable an operator to move the cutter 220 into a cutting position, which will be discussed in further detail below. The second planar body 207 includes at least one slot 252, which operatively connects the second planar body 207 to the first planar body 206 via a fastener 254 proximate the rear end 204. The planar body 207 includes a second slot (not shown) substantially similar to the slot 252 on an opposite side wall, which operatively connects the second planar body 207 to the first planar body 206 via a fastener 256.

Referring to FIG. 5, the second planar body 207 includes a top surface 207a, a bottom surface 207b, and an opening 260 sized and shaped to allow the cutter 220 to extend through the second planar body 207 (cutter 220 extending through the second planar body 207 not shown). The opening 260 may be, in one or more embodiments, substantially similar to the opening 224.

Returning to the embodiment shown FIG. 4, the planar body assembly 201 proximate the front end includes two fasteners 262 and 264 that operatively connect the first planar body 206 to the second planar body 207 through holes in the first planar body 206 (not shown) and the second planar body 207 (not shown). The fasteners 262 and 264 are a nut and bolt configuration, but may be any suitable fasteners that allow the first planar body 206 and the second planar body 207 to pivot about the fasteners 262 and 264.

The planar body assembly 201 includes one or more springs (not shown) that bias the first planar body 206 apart from the second planar body 207 (e.g., so when the one or more springs are extended, the cutter 220 does not substantially extend through the second planar body 207, but when the one or more springs are compressed, the cutter 220 extends through the second planar body 207). In various embodiments, the one or more springs are located between the first planar body 206 and the second planar body 207. In one or more embodiments, the one or more springs are operatively located between each of the fasteners 254 and 256 (e.g., there may be a spring between the fastener 254 and a top surface of the first planar body 206 and/or a spring between the fastener 256 and a top surface of the first planar body 206). It should be understood in light of this disclosure that any other mechanism known in the art may be used to bias the first planar body 206 away from the second planar body 207.

### First Alternate Embodiment Operation

A brief example of the operation of the embodiment of the planar cutting tool 200 shown in FIGS. 4-5 may be useful. In this example, an operator holds the planar cutting tool via the front handle 216 and the rear handle 210. The operator, in this example, places the planar cutting tool 200 on a piece of heavy drywall (or any other material the operator wishes to cut), with a bottom surface of the second planar body 207 resting substantially flat against the heavy drywall. The operator then, in this particular example, aligns the planar cutting tool 200 with the portion the operator wishes to cut in any suitable way, including but not limited to, using one or more notches, one or more holes in the planar cutting tool 200 (not shown), one or more accessories (including a slat jack, T-square, etc.), and/or one or more laser sights mounted to the planar cutting tool 200. Once the planar cutting tool 200 is aligned, the operator exerts downward force on the rear handle 210, which moves the first planar body 206 and the cutter holding assembly 222 downward, overcoming the bias of the one or more springs between the first planar body 206 and the second planar body 207 moving the cutter 220 through the opening 260 in the planar body 207. In this way, in this example, the cutter 220 engages the heavy drywall. The operator then, in this example, pushes the planar cutting tool 200 forward, cutting the heavy drywall.

### Second Alternate Embodiment

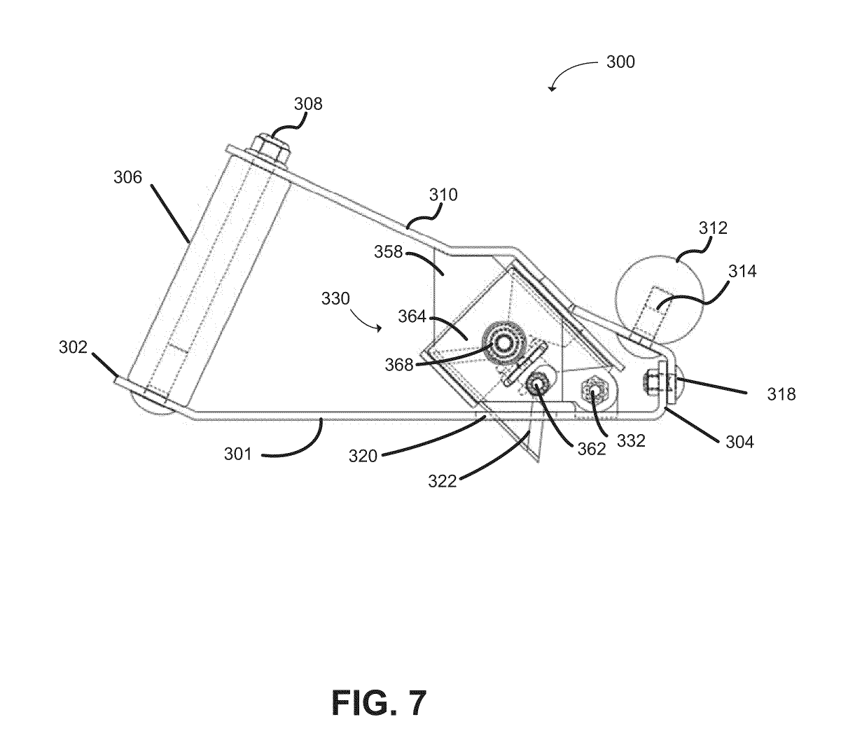

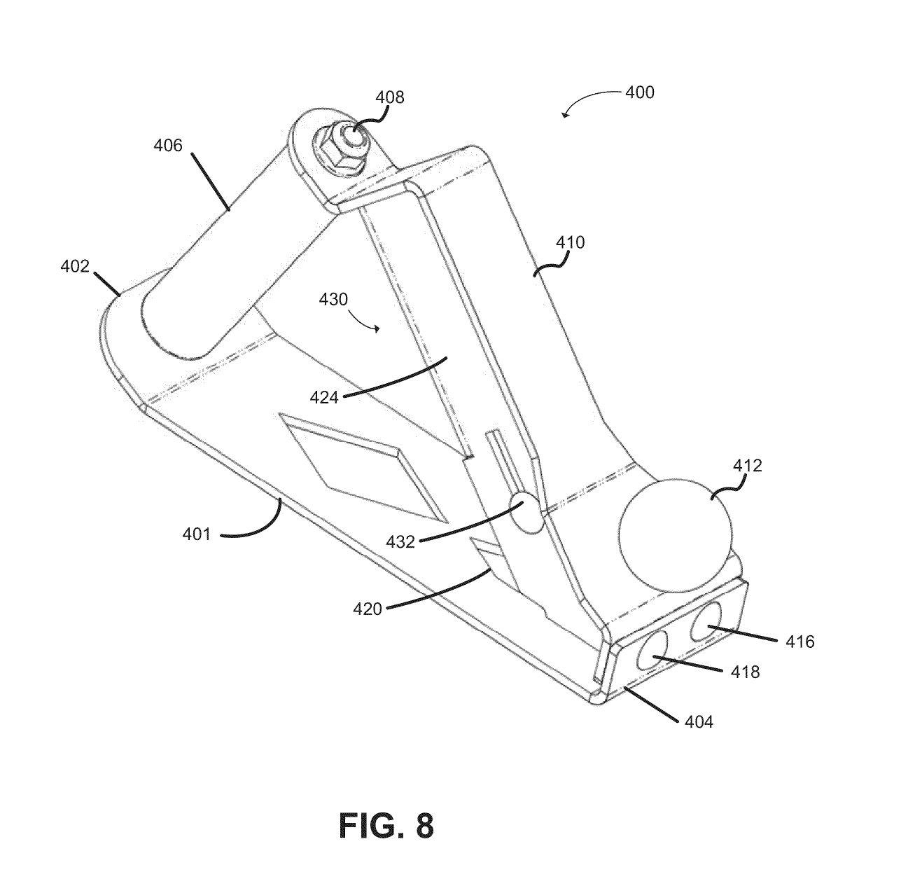

FIGS. 6 and 7 depict a second alternate exemplary embodiment of the planar cutting tool. In FIGS. 6 and 7, a planar cutting tool 300 that is similar in some aspects to the planar cutting tool 200 discussed above (as shown in FIGS. 4, 4A, and 5) is shown. The planar cutting tool 300 is, generally speaking, the planar cutting tool 200 without the second planar body 207 (FIG. 4) and with the cutter holding assembly 222 (FIG. 4) oriented such that a cutter 322 in the present embodiment is in the opposite direction of the cutter 222 in the embodiment shown in FIG. 4. In this way, the planar cutting tool 300 is a “draw” cutting tool (e.g., the operator pulls the cutting tool instead of pushing it) with the cutter 322 fixed in a cutting position when a bottom surface of the planar cutting tool 300 is substantially engaged with a cutting surface. Specific features of the planar cutting tool 300 will now be discussed.

Turning to the embodiment depicted in FIG. 6, the planar cutting tool 300 includes a planar body 301 that has a rear end 302 and a front end 304. The planar body 301 is operatively connected to a rear handle 306 via a fastener 308 (or the rear handle 306 may be integrally formed with the planar body 301) and the rear handle 306 is operatively connected to the planar body 301 in the same way the rear handle 210 is operatively connected to the planar body 206 in FIG. 4. The rear handle 306 is operatively connected to a support arm 310, which is operatively connected to a front handle 312, via a suitable fastener 314 (FIG. 7), or the front handle 312 may be integrally formed with the support arm 310. The support arm 310 operatively connects to the planar body 301 proximate the front end 304 of the planar body 301 via one or more suitable fasteners 316 and 318. The planar body 301 defines an opening 320, which may be sized and shaped to allow the cutter 322 to pass through the planar body 301.

The cutter 322 is positioned perpendicular to the planar body 301 and extends through the opening 320 (e.g., between the front end 304 of the planar cutting tool 300 and the rear end 302 of the planar cutting tool 300) such that a cutting portion of the cutter 320 may be facing toward the rear end 302 of the planar cutting tool 300. The cutter 322 is positioned as such by the cutter holding assembly 330, which may be operatively connected to the support arm 310 (e.g., by weldment and/or any other suitable fastener) and the planar body 301 via any suitable fastener 332. The cutter holding assembly 330 is structurally substantially similar to the cutter holding assembly 222 as depicted in FIG. 4.

In various embodiments, the support arm 310 may be integrally formed with the planar body 301 (not shown). In further embodiments, the planar body 301, the support arm 310, and the rear handle 306 may be integrally formed (e.g., the planar body 301, the support arm 310, and the rear handle 306 are substantially one piece).

### Third Alternate Embodiment

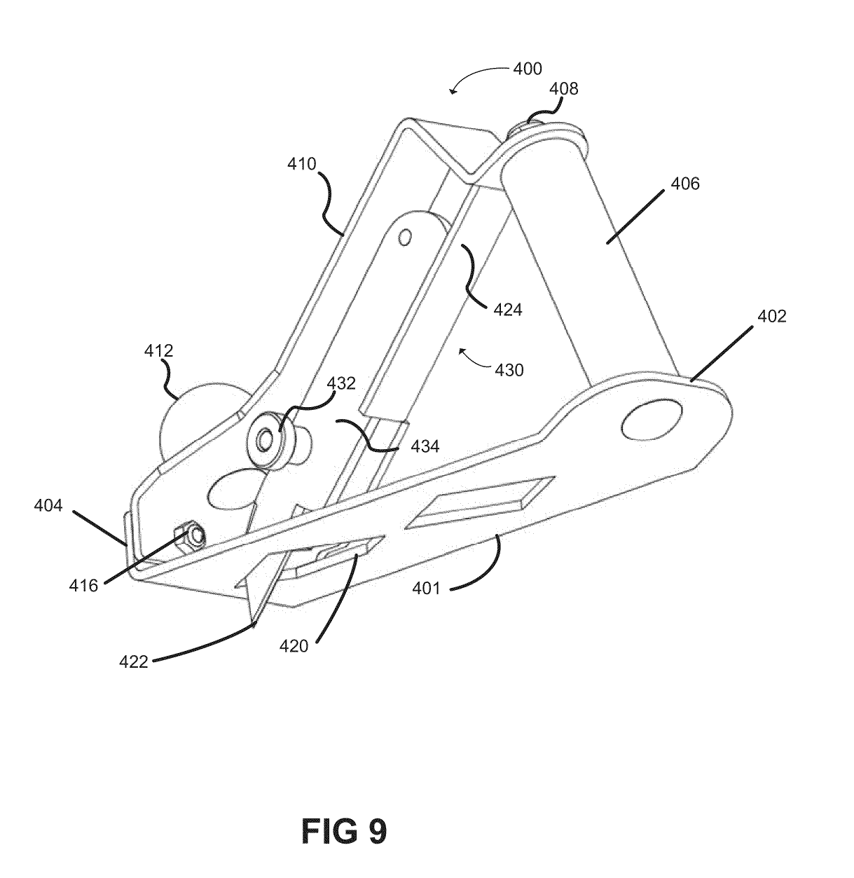

FIGS. 8, 9, and 10 depict a third exemplary embodiment of the planar cutting tool. In FIGS. 8, 9 and 10, a planar cutting tool 400 that is substantially similar to the planar cutting tool 300 discussed above (as shown in FIGS. 6 and 7) is shown. The planar cutting tool 400 is, generally speaking, similar to the planar cutting tool 300 shown in FIGS. 6 and 7, but the planar cutting tool 400 uses a different cutter holding assembly 430 (e.g., different than cutter holding assembly 330) that is similar, in some respects, in structure to the cutter assembly 32 (as shown in FIG. 1). Like the cutting tool 300 in FIGS. 6 and 7, the planar cutting tool 400 is a “draw” cutting tool (e.g., the operator pulls the cutting tool instead of pushing the planar cutting tool 400 to cut material). Specific features of the planar cutting tool 400 will now be discussed.

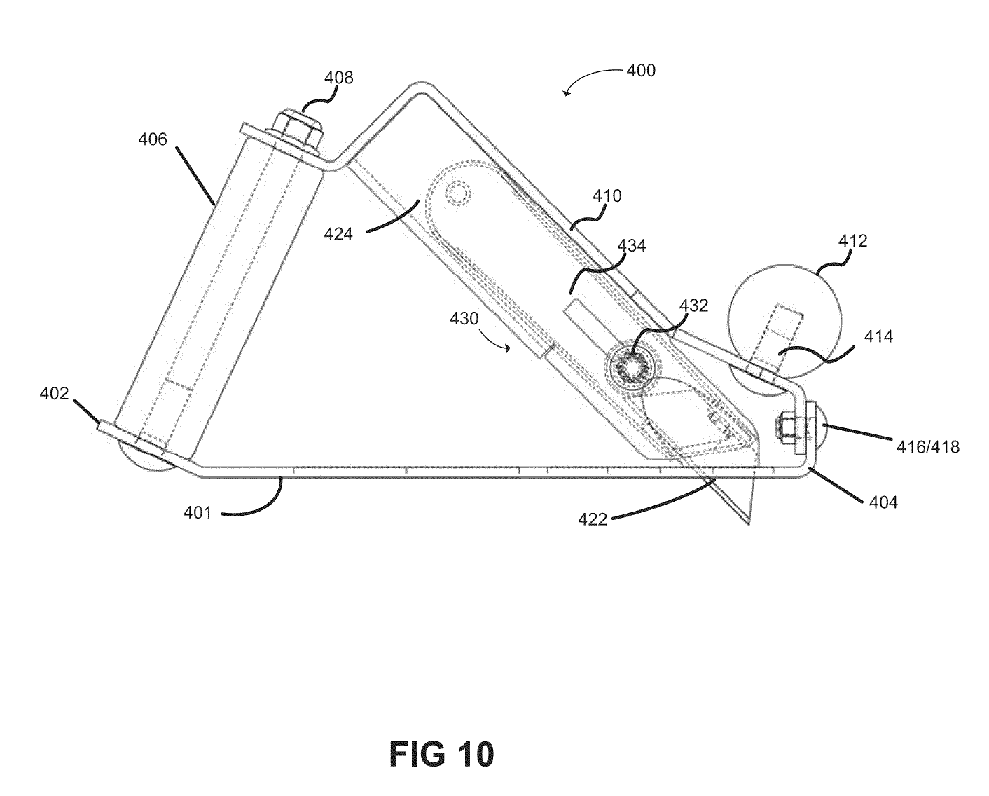

Turning to the embodiment depicted in FIG. 8, the planar cutting tool 400 includes a planar body 401 that has a rear end 402 and a front end 404. The planar body 401 is operatively connected to a rear handle 406 via a suitable fastener 408 (or the rear handle 406 may be integrally formed with the planar body 401). The rear handle 406 is operatively connected to a support arm 410, which is operatively connected to a front handle 412, via a suitable fastener 414 (FIG. 10) or the front handle 412 is integrally formed with the support arm 410. The support arm 410 operatively connects to the planar body 401 proximate the front end 404 of the planar body 401 via one or more suitable fasteners 416 and 418. The planar body 401 defines an opening 420 that is sized and shaped to allow a cutter 422 (FIG. 9) to pass through the planar body 401.

Turning to FIG. 9, the planar cutting tool 400 includes a support bracket 424. The support bracket 424 is integrally formed with the support arm 410, but it should be understood that the support bracket 424 may be operatively connected to the support arm 410 by any suitable fastener, such as a weldment, a nut and bolt, a screw, a snap, etc. The support bracket 424 is operatively connected to the planar body 401 proximate the front end 404 of the planar cutting tool 400. Although the support bracket 424 is shown as integrally formed with the planar body 401, it should be understood, in light of this disclosure, that the support bracket 424 may be operatively connected with the support arm 410 and/or the planar body 401 via any suitable fastener.

Referring to FIG. 10, the support bracket 424 operatively connects to a cutter housing 434 via a fastener 432 (e.g., the fastener 432 couples to the cutter housing 434 by a hole (not shown) in the cutter housing 434). The cutter housing 434 may be substantially similar to the left and right housing portions 33 and 34 as described above in FIG. 1 (e.g., the cutter housing may be a retail utility-type knife that may, or may not, be modified to operatively connect to the support bracket 424 via the fastener 432), but it should be understood that the cutter housing 434 may be any suitable cutter housing, modified, or not modified.

### Fourth Alternate Embodiment

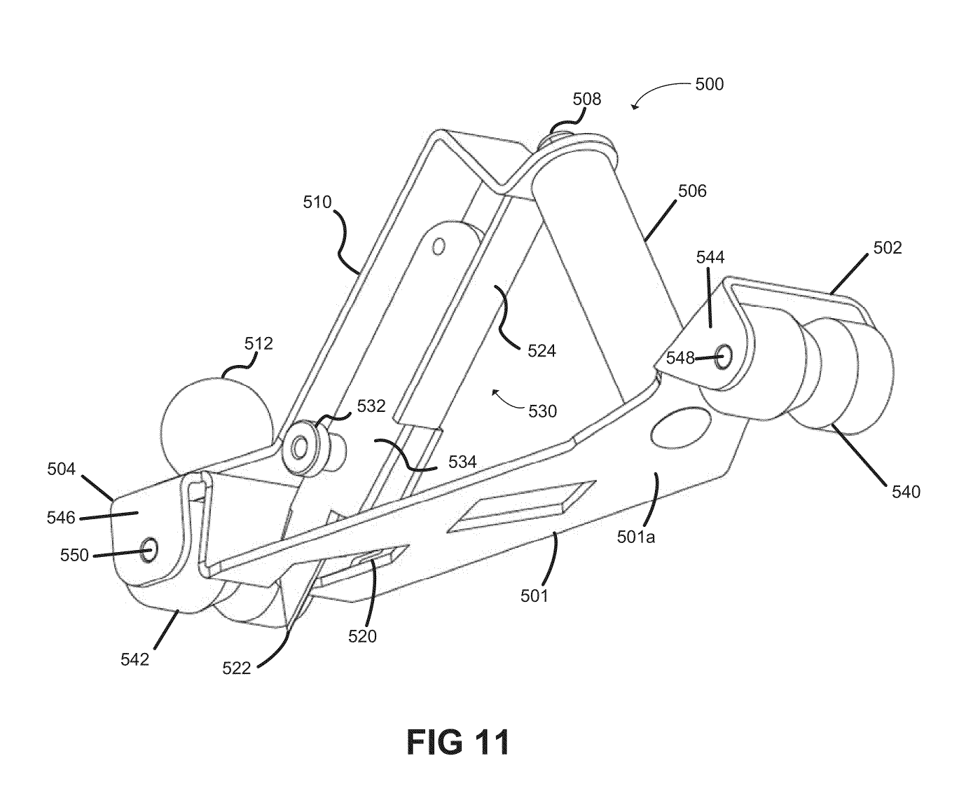

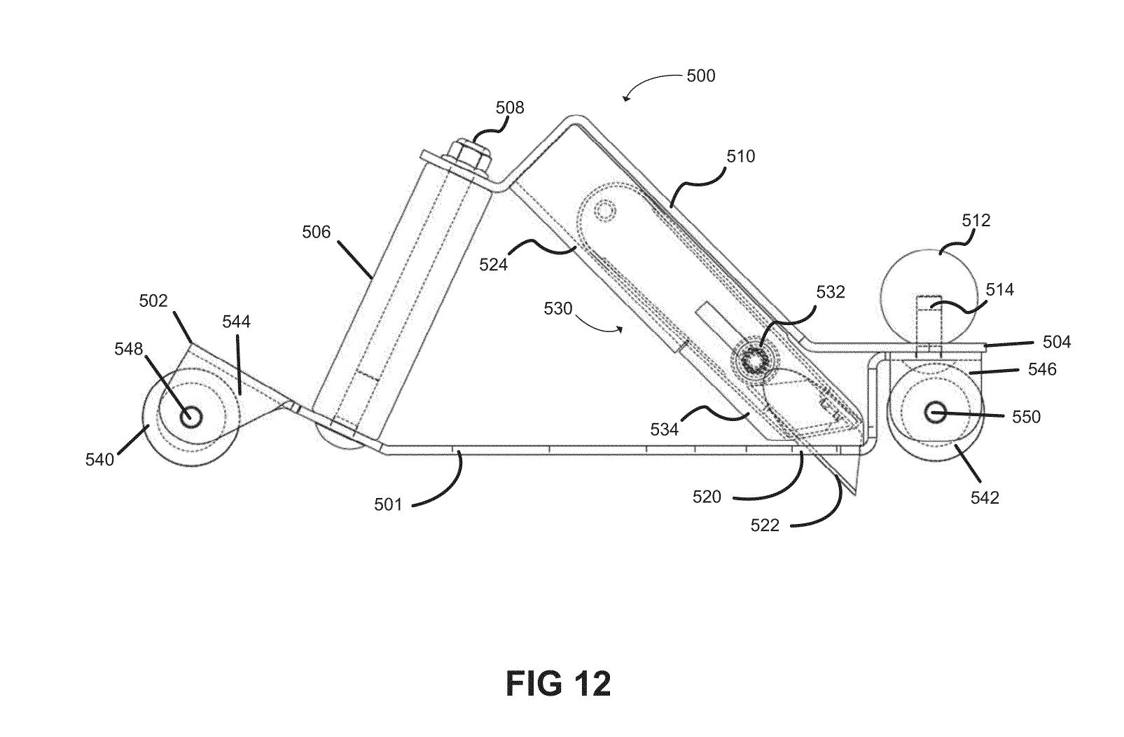

FIGS. 11 and 12 depict a fourth exemplary embodiment of the planar cutting tool. In FIGS. 11 and 12, a planar cutting tool 500 is shown. The planar cutting tool 500 has one or more similar features as the planar cutting tool 400 discussed above (as shown in FIGS. 8, 9, and 10). The planar cutting tool 500 is, generally speaking, similar to the planar cutting tool 400, except the planar cutting tool 500 may be adapted to include two rollers (e.g., two devices to reduce the friction between the planar cutting tool 500 and the cutting material and/or surface). Like the exemplary cutting tool 400 in FIGS. 8, 9, and 10, the planar cutting tool 500 may be a “draw” cutting tool (e.g., the operator pulls the cutting tool (e.g., like planar cutting tool 300 shown in FIGS. 6 and 7) instead of pushing the planar cutting tool to cut material). Specific features of the planar cutting tool 500 will now be discussed.

Turning to the embodiment depicted in FIG. 11, the planar cutting tool 500 includes a planar body 501 that has a rear end 502 and a front end 504. The planar body 501 operatively connects to a rear handle 506 via a suitable fastener 508 (or the rear handle 506 may be integrally formed with the planar body 501). The rear handle 506 operatively connects to a support arm 510 via the fastener 508. The support arm operatively connects to a front handle 512, via a suitable fastener 514 (FIG. 12), or the front handle 512 may be integrally formed with the support arm 510. The planar body 501 defines an opening 520, which may be sized and shaped to allow a cutter 522 to pass through the planar body 501.

Continuing with FIG. 11, the planar cutting tool 500 includes a support bracket 524. In the embodiment shown in FIG. 11, the support bracket 524 is integrally formed with the support arm 510 and is operatively connected to the planar body 501 proximate the front end 504 of the planar cutting tool 500. Although the support bracket 524 is shown as integrally formed, it should be understood, in light of this disclosure, that the support bracket 524 may be operatively connected with the support arm 510 and/or the planar body 501 via any suitable fastener.

The support bracket 524 operatively connects to a cutter housing 534 via a fastener 532. The cutter housing 534 may be substantially similar to the left and right housing portions 33 and 34 as described above in FIG. 1 (e.g., the cutter housing may be a retail utility-type knife that may be modified to operatively connect to the support bracket 524 via the fastener 532), but it should be understood that the cutter housing 534 may be any suitable cutter housing.

Continuing with FIG. 11, the planar cutting tool 500 includes two rollers 540 and 542. The rollers 540 and 542 are substantially cylindrical wheels operatively connected to roller housings 544 and 546, respectively. The rollers 540 and 542 are operatively connected to the roller housings 544 and 546 via rods 548 and 550, respectively (e.g., each of the rods 548 and 550 pass through a hole (not shown) in the respective roller 540 and 542). Each rod 548 and 550 operatively connects to their respective roller housing 544 and 546 so that the rollers 540 and 542 rotate about the rods on axial bearings (not shown). The roller housings 544 and 546 are each substantially flat plates formed to a substantial downward C-shape (e.g., a C-shape that opens downward when a bottom surface 501a of the planar body 501 is in contact with a material to be cut by the planar cutting tool 500).

It should be understood, in light of this disclosure that the rollers 540 and 542 may be any suitable mechanisms for reducing the friction between the planar cutting tool 500 and a material (e.g., a material that is making contact with a bottom surface of the planar body 501) when the planar cutting tool is pulled (e.g., drawn) to cut the material such as, for example: (1) one or more bearings; (2) one or more wheels; (3) one or more lubricants (e.g., lubricants applied to any portion of the planar cutting tool 500).

### Fifth Alternate Embodiment

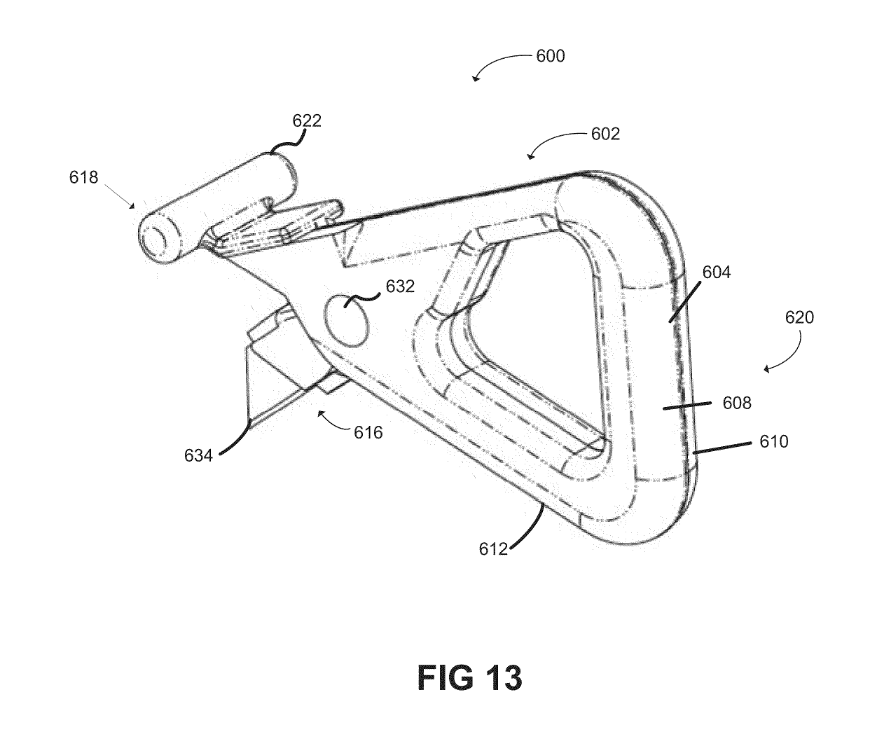

FIGS. 13, 14, and 15 depict a fifth exemplary embodiment of the planar cutting tool. In FIGS. 13, 14, and 15, a planar cutting tool 600 is shown. The planar cutting tool 600 includes a body 602 that generally integrates a rear handle 604 and holds a cutter assembly 616 in position. The body 602 includes a left body portion 608, a right body portion 610, a bottom surface 612, a slot 614 (FIG. 14) for receiving the cutter 634, a front end 618, and a rear end 620. The left body portion 608 and the right body portion 610 are formed from a hard metal (i.e. die-cast aluminum) and are operatively coupled together by a fastener 632, which is a carriage head screw and nut configuration. It should be understood, in light of this disclosure, that the left body portion 608 and the right body portion 610 may be operatively coupled in any suitable way, including using internal snaps (not shown), weldment, epoxy, screws, bolts, etc., and may be formed from any suitable material including hard plastic, carbon fiber, etc.

The body 602 contains a T-shaped front handle 622 integral to the right body portion 610 proximate the front end 618 of the body 602. It should be understood, in light of this disclosure, that the T-shaped front handle 612 may be operatively coupled to the body 602 in any suitable way depending on what material forms the body 602 (e.g., if the body 602 is a hard plastic, an epoxy may be used to couple the T-shaped front handle 622 to the body 602).

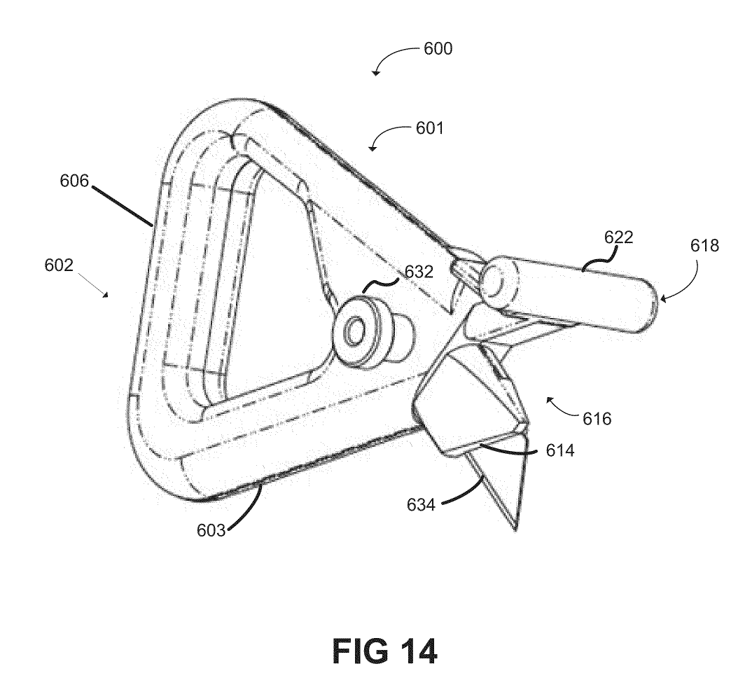

Referring to FIGS. 14 and 15, the body 602 receives the cutter 634 through the slot 614. The cutter assembly 616 is integral to the body 602. The slot 614 is sized and shaped to hold the cutter 634 in a position so that the cutter 634 is positioned to cut a material when the planar cutting tool 600 is pulled by an operator (e.g., when the bottom surface 612 of the body 602 is in contact with at least a portion of the material). The cutting tool 600 may also be used when the bottom surface 612 is parallel to, or at an angle to, the cutting surface of the material. The cutter assembly 616 is substantially similar to the cutter assembly 32 as shown in FIG. 1, except the cutter assembly 616 has been shortened (e.g., the distance between the cutter 634 and the opposite end of the cutter assembly 616 is shorter than the distance between the cutter 28 and the opposite end of the cutter assembly 32 as shown in FIG. 1).

### Sixth Alternate Embodiment

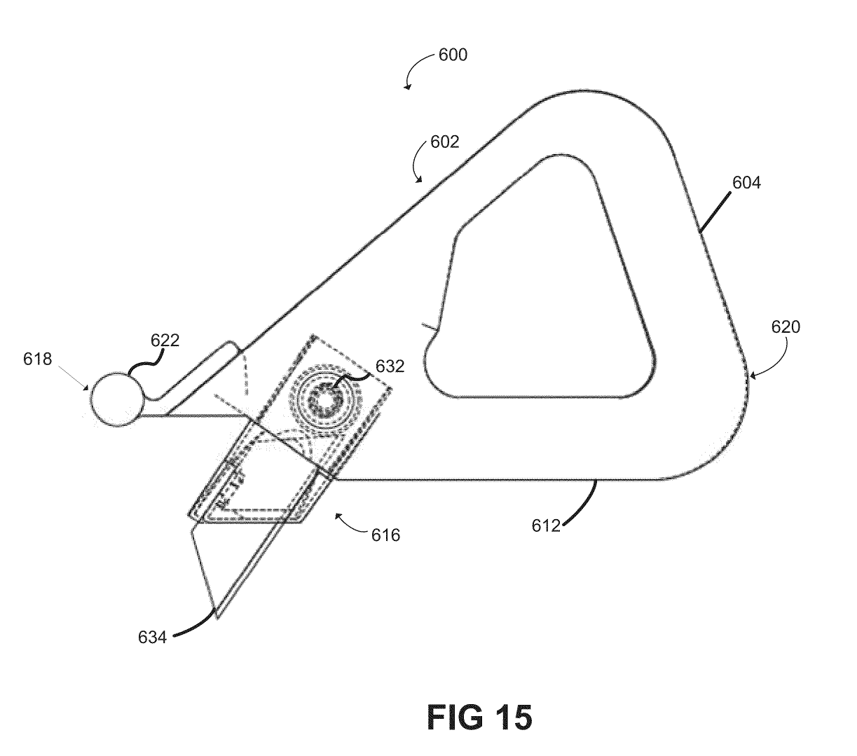

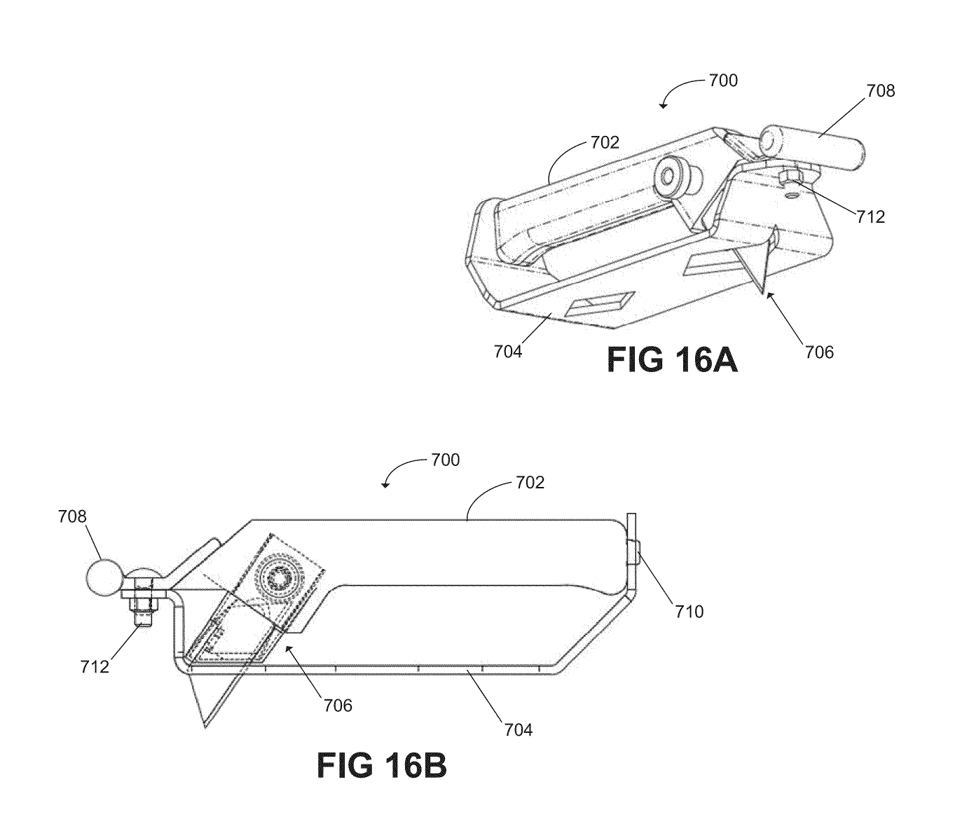

FIGS. 16A and 16B show a sixth alternate exemplary embodiment of a planar cutting tool 700, which includes a cutting assembly that is substantially similar to that shown in the embodiment of FIGS. 13-15. This embodiment, as shown, has an alternate rear handle 702, a planar base 704, a cutter assembly 706, and a T-shaped front handle 708. The rear handle 702 holds the cutter assembly 706 in position and is operatively coupled to the planar base 704 via a suitable fastener 710 (FIG. 16B) (e.g., a pin and hole configuration where the tension of the planar base 704 holds the rear handle 702 substantially in position in conjunction with a fastener 712). The T-shaped front handle 708 is coupled (e.g., connected or integrally formed) to the rear handle 702 and operatively coupled to the planar base by the nut and bolt arrangement fastener 712 (or any other suitable fastener discussed herein). It should be noted, that in this particular embodiment, an operator can either push or pull the planar cutting tool 700 with one hand or both hands. For example, if the operator grips the rear handle 702 with one hand while the planar base 704 is in contact with a cutting surface, the operator can push (as opposed to pulling using the front handle 708 in conjunction with the rear handle 702) the planar cutting tool 700 using only the rear handle.

### Additional Planar Cutting Tool Notes

The planar cutting tool, as described herein, may incorporate any of the above features into any of the designs described. In various embodiments, for example, the planar cutting tool of embodiment 1 (e.g., FIG. 1) may incorporate a custom cutter assembly substantially similar to the custom cutter assembly in the planar cutting tool of embodiment 300 (e.g., FIG. 4A). Any of the embodiments discussed above may be operational in either a draw (e.g., an operator pulls the planar cutting tool to cut material) or a push direction (e.g., the operator pushes the planar cutting tool to cut material).

Any of the planar cutting tool embodiments described herein may include additional features. In various embodiments, the planar cutting tool includes an adjustable handle (e.g., the front handle and/or the rear handle are adjustable). In one or more embodiments, the planar cutting tool includes a laser guide (e.g., a retail laser guide such as a Bosch Self-Leveling Cross-Line Laser, Model No. GLL2-40, or any other suitable model) mounted to the planar cutting tool in any suitable location. In further embodiments, the planar cutting tool includes one or more motors to assist with moving the planar cutting tool (e.g., a motor that drives rollers such as the planar cutting tool 500 shown in FIG. 11) and/or moving the cutter (e.g., in a sawing and/or lateral motion).

### CONCLUSION

Many modifications and other embodiments of the invention will come to mind to one skilled in the art to which this invention pertains having the benefit of the teachings presented in the foregoing descriptions and the associated drawings. For example, as will be understood by one skilled in the relevant field in light of this disclosure, the invention may take form in a variety of different mechanical and operational configurations. Therefore, it is to be understood that the invention is not to be limited to the specific embodiments disclosed and that the modifications and other embodiments are intended to be included within the scope of the appended exemplary concepts. Although specific terms are employed herein, they are used in a generic and descriptive sense only and not for the purposes of limitation. The description of the above exemplary embodiments should teach one of skill in the art that many more alternatives exist.

We claim:

1. A planar cutting tool comprising:
a. a body comprising:
i. a substantially flat top surface;
ii. a substantially flat bottom surface;
iii. a front end;
iv. a back end; and
v. a longitudinal axis extending between the body front end and the body back end;
b. a first handle coupled to said body proximate said body front end;
c. a second handle coupled to said body proximate said body back end; and
d. a cutting assembly operatively connected to said body comprising:
i. a cutter having a cutting edge; and
ii. a cutter housing for securing said cutter to said body in a position where said cutting edge is parallel to a plane that encompasses said longitudinal axis.

2. The planar cutting tool of claim 1, wherein said cutter holder further comprises a housing configured to secure the cutter in a particular orientation, wherein said housing is operatively connected to said body top surface.

3. The planar cutting tool of claim 1, wherein said cutter is a cutter selected from the group consisting of:
a. a utility knife;
b. a hook blade;
c. a razor blade; and
d. a tile blade.

4. The planar cutting tool of claim 3, wherein said cutter is a retail utility knife.

5. The planar cutting tool of claim 2, wherein said cutter assembly further comprises:
a. a front mount operatively connected to said body top surface and said cutter housing; and
b. a rear mount operatively connected to said body top surface and said cutter housing.

6. The planar cutting tool of claim 5, wherein said cutter assembly further comprises a support bracket that is:
a. adjustably connected to said front mount;
b. adjustably connected to said rear mount; and
c. operatively connected to said cutter housing.

7. The planar cutting tool of claim 6, wherein said cutter housing is adjustable in a direction perpendicular to said body top surface.

8. The planar cutting tool of claim 7, wherein said cutter assembly is moveable between:
a. a first position in which said cutting edge at least partially extends through said body top and bottom surfaces; and
b. a second position in which said cutting edge does not at least partially extend through said body bottom surface.

9. The planar cutting tool of claim 1, wherein said first handle is substantially round.

10. The planar cutting tool of claim 9, wherein:
a. said planar cutting tool further comprises a rear handle mounting bracket:
(1) extending from said body top surface; and
(2) comprising at least one angle; and
b. said second handle:
(1) is substantially cylindrical;
(2) defines a vertical central axis; and
(3) is operatively connected to said rear handle mounting bracket such that said second handle vertical central axis forms a first acute angle with said body top surface.

11. The planar cutting tool of claim 10, wherein said rear handle mounting bracket is extended from said body top surface by a construction method selected from the group consisting of:
a. operatively connected to said body by one or more fasteners; and
b. integrally formed with said body.

12. The planar cutting tool of claim 10, wherein:
a. said rear handle mounting bracket is located proximate said body back end; and
b. said first acute angle is between said second handle vertical central axis and said body front end.

13. The planar cutting tool of claim 11, wherein:
a. said planar cutting tool further comprises a front handle mounting bracket, said front handle mounting bracket:
(1) extending from said body top surface;
(2) located proximate the body front end; and
(3) comprising at least one angle; and
b. said first handle:
(1) defines a vertical central axis;
(2) is operatively connected to said front handle mounting bracket such that said first handle vertical central axis forms a second acute angle with said body top surface.

14. The planar cutting tool of claim 10, wherein said front handle mounting bracket is extended from said body top surface by a construction method selected from the group consisting of:
a. operatively connected to said body by one or more fasteners; and
b. integrally formed with said body.

15. The planar cutting tool of claim 13, wherein said second acute angle is between said first handle vertical central axis and said body back end.

16. The planar cutting tool of claim 1, wherein said planar cutting tool further comprises a support arm, said support arm operatively connected to each of said body top surface and said second handle.

17. The planar cutting tool of claim 14, wherein said first handle is operatively connected to said support arm.

18. The planar cutting tool of claim 15, wherein:
a. said cutter assembly is operatively connected to said support arm; and
b. said second handle is operatively connected to said support arm and to said body top surface.

19. The planar cutting tool of claim 16, wherein said cutter assembly is substantially positioned:
a. between said first handle and said second handle; and
b. between said support plate and said body top surface.

20. The planar cutting tool of claim 1, wherein said cutter is substantially positioned such that said cutting edge is facing said body back end.

21. The planar cutting tool of claim 1, wherein said cutter is substantially positioned such that said cutting edge is facing said body front end.

22. A planar cutting tool comprising:
a. a body comprising:
(1) a front end;
(2) a back end; and
(3) a longitudinal axis extending between the body front end and the body back end;
b. at least one handle coupled to said body intermediate said body front and back ends; and
c. a cutter assembly operatively connected to said body comprising:
(1) a cutter having a cutting edge;
(2) a cutter housing for securing said cutter to said body in a position where said cutting edge coplanar with said longitudinal axis;
(3) a front mount operatively connected to said body and said cutter housing; and
(4) a rear mount operatively connected to said body and said cutter housing;
(5) wherein said cutter assembly further comprises a support bracket that is:
1. adjustably connected to said front mount;
2. adjustably connected to said rear mount; and
3. operatively connected to said cutter housing.

23. The planar cutting tool of claim 22, further comprising a second handle coupled to said body intermediate said at least one handle and said front end of said body.

24. A planar cutting tool comprising:
a. a substantially rectangular body comprising:
(1) a front end;
(2) a back end;
(3) a substantially flat top surface that extends between said front and back ends; and
(4) a longitudinal axis extending between said body front and back ends;
b. at least one handle coupled to said substantially rectangular body intermediate said body front and back ends; and
c. a cutter operatively connected to said body, wherein:
(1) said cutter defines an elongated cutting edge;
(2) said cutting edge at least partially extends through said body so that said cutting edge is coplanar with said body longitudinal axis; and
(3) at least a portion of said cutter extends perpendicular to said top surface of said substantially rectangular body.

25. The planar cutting tool of claim 24, wherein said at least one handle is substantially T-shaped.

26. The planar cutting tool of claim 25, further comprising a second handle that is coupled to said body intermediate said at least one handle.

27. The planar cutting tool of claim 24, wherein said cutter is substantially positioned such that said cutting edge is facing said body back end.

28. The planar cutting tool of claim 24, wherein said cutter is substantially positioned such that said cutting edge is facing said body front end.

29. The planar cutting tool of claim 24, wherein said cutter is adjustable to allow a length of the cutting edge that extends through said body to change.
